(19) United States
(12) Patent Application Publication
(10) Pub. No.: US 2016/0343104 A1
(43) Pub. Date: Nov. 24, 2016

(54) Displaying Method and Display Terminal

(71) Applicants: Beijing BOE Display Technology Co., Ltd., Beijing (CN); BOE Technology Group Co., Ltd., Beijing (CN)

(72) Inventor: Bin Zhang, Beijing (CN)

(73) Assignees: BOE Technology Group Co., Ltd., Beijing (CN); Beijing BOE Display Technology Co., Ltd., Beijing (CN)

(21) Appl. No.: 14/897,429

(22) PCT Filed: Jul. 17, 2015
(86) PCT No.: PCT/CN2015/084329

§ 371 Date: Dec. 10, 2015

(30) Foreign Application Priority Data
Dec. 19, 2014 (CN) 201410802581.0

(51) Int. Cl. G06T 1/20; G09G 5/00; G06T 3/40

(52) U.S. Cl. CPC G06T 1/20; G06T 3/40; G09G 5/006

(57) ABSTRACT

There are provided a displaying method and a display terminal. The displaying method comprises: acquiring a usage mode of the display terminal (S1); and determining an effective use area of a display screen (1) in the display terminal according to the usage mode (S2). The displaying method and display terminal detect the usage mode of the display terminal in real time, and adjust the effective use area of the display screen in the display terminal according to the usage mode, so that the user's different requirements for the liquid crystal screen in different usage modes are satisfied, and thus the user experience is raised.

### TECHNICAL FIELD

The present disclosure relates to a displaying method and a display terminal.

### BACKGROUND

At present, since a tablet computer is mainly focused on entertainment function, its capability in office processing is relatively deficient. Then, a two-in-one computer of PC and tablet begins to appear on the market, that is, a two-in-one computer of PC and tablet including a host base and a tablet. The tablet can be combined with the host base to form a notebook computer for handling some more complicated work. The tablet can also be taken from the host base to be used as a tablet for entertainment and so on.

However, at present, a display area of a display screen in the two-in-one computer of PC and tablet has already been fixed at the beginning of design generally. In this way, especially in the case of a narrow frame being popular, when a user takes the two-in-one computer of PC and tablet as a tablet, it is always easy to cause false operation because the operation is performed through the screen, thereby resulting in the problem of low user experience.

### SUMMARY

Embodiments of the present disclosure provide a displaying method and a display terminal, which are capable of raising a user's using experience.

According to one aspect of the present disclosure, there is provided a displaying method, comprising following steps:

acquiring a usage mode of the display terminal; and

determining an effective use area of a display screen in the display terminal according to the usage mode.

Further, acquiring a usage mode of the display terminal comprises:

determining the usage mode of the display terminal according to whether the display terminal is connected to an external device.

Further, acquiring a usage mode of the display terminal further comprises:

determining the usage mode of the display terminal according to a control signal inputted by a user.

Further, a priority of the control signal inputted by the user is higher than that of the external device when the usage mode of the display terminal is determined.

Further, determining an effective use area of a display screen in the display terminal according to the usage mode comprises:

performing a first process on image data inputted to the display screen when the usage mode is a PC usage mode, to obtain display data of a first resolution, wherein the first resolution is equal to a resolution of the display screen, and the display screen displays the display data of the first resolution in a point-to-point display mode; and

performing a second process on image data inputted to the display screen when the usage mode is a tablet usage mode, to obtain display data of a second resolution, wherein the second resolution is smaller than a resolution of the display screen, and the display screen displays the display data of the second resolution in a point-to-point display mode.

According to another aspect, there is further provided a display terminal. The display terminal comprises a display screen, and further comprises:

an acquiring module configured to acquire a usage mode of the display terminal; and

an executing module configured to determine an effective use area of the display screen in the display terminal according to the usage mode.

Further, the acquiring module comprises:

a first acquiring unit configured to determine the usage mode of the display terminal according to whether the display terminal is connected to an external device.

Further, the acquiring module further comprises:

a second acquiring unit configured to determine the usage mode of the display terminal according to a control signal inputted by a user.

Further, a priority of the second acquiring module is higher than that of the first acquiring unit.

Further, the executing unit comprises:

a processing unit configured to perform a first process on image data inputted to the display screen when the usage mode is a PC usage mode, to obtain display data of a first resolution, wherein the first resolution is equal to a resolution of the display screen and perform a second process on image data inputted to the display screen when the usage mode is a tablet usage mode, to obtain display data of a second resolution, wherein the second resolution is smaller than a resolution of the display screen; and

an outputting unit configured to input display data processed and obtained by the processing unit to the display screen, wherein the display screen displays the display data received from the output unit in a point-to-point display mode.

The displaying method and display terminal of the present disclosure detect the usage mode of the display terminal in real time, and adjust the effective use area of the display screen in the display terminal according to the usage mode, so that the user's different requirements for the liquid crystal screen in different usage mode are satisfied, and thus the user experience is raised.

### BRIEF DESCRIPTION OF THE DRAWINGS

FIG. 1 is a flow diagram of a displaying method provided in an embodiment of the present disclosure;

FIG. 2 is a schematic diagram of a display terminal provided in an embodiment of the present disclosure;

FIG. 3 is a schematic diagram of an output signal of a first acquiring unit provided in an embodiment of the present disclosure;

FIG. 4 is a schematic diagram of an output signal of a second acquiring unit provided in an embodiment of the present disclosure;

FIG. 5 is a schematic diagram of a display terminal in a PC usage mode provided in an embodiment of the present disclosure;

FIG. 6 is a schematic diagram of a display terminal in a tablet usage mode provided in an embodiment of the present disclosure.

### DETAILED DESCRIPTION

Specific implementations of the present disclosure will be described below in detail by combining with figures and embodiments. Following embodiments are just used for describing the principle of the present disclosure, but not used for limiting the scope of the present disclosure.

FIG. 1 is a flow diagram of displaying method provided in an embodiment of the present disclosure. The method comprises following steps:

step S1: acquiring a usage mode of a display terminal;

step S2: determining an effective use area of a display screen in the display terminal according to the usage mode.

In an alternative embodiment, step S1 can comprise:

determining the usage mode of the display terminal according to whether the display terminal is connected to an external device. Herein, the external device can include a base, a keyboard, and a mouse and so on. The display terminal can detect statuses of respective external interfaces of the display terminal itself in real time. When it is determined that there is an external device connected to the display terminal, it can be regarded that the current usage mode is a PC usage mode; when there is no external device connected to the display terminal, it can be regarded that the current usage mode is a tablet usage mode.

Exemplarily, the usage mode of the display terminal can also be determined according to a control signal inputted by the user, so that it is convenient for the user to change the usage mode of the display apparatus at any time according to his/her desire, and thus the user experience is raised.

In addition, in order to raise the user's control ability to the display terminal, when the usage mode of the display terminal is determined, a priority of the control signal inputted by the user is higher than that of the external device. For example, when the display terminal is not connected to any external device, the display terminal is the tablet usage mode; when it is received that the control signal inputted by the user is the PC usage mode, the table usage mode is converted into the PC usage mode.

In the method as shown in FIG. 1, step S2 can comprise:

performing a first process on image data inputted to the display screen when the usage mode is the PC usage mode, to obtain display data of a first resolution, where the first resolution is equal to a resolution of the display screen, and the display screen displays the display data of the first resolution in a point-to-point display mode; and

performing a second process on image data inputted to the display screen when the usage mode is the tablet usage mode, to obtain display data of a second resolution, where the second resolution is smaller than a resolution of the display screen, and the display screen displays the display data of the second resolution in a point-to-point display mode.

For example, for a liquid crystal screen having a resolution of 1920×1080, when the usage mode is the PC usage mode, the image data inputted to the display screen is processed into display data of 1920×1080. After receiving the display data, the display screen displays it in the point-to-point mode (i.e., pixels in the liquid crystal screen and pixels of the display data are displayed one to one, so that the entire screen of the display screen are filled with images. When the usage mode is the PC usage mode, the image data inputted to the display screen is processed into display data of 1366×768. After receiving the display data, the display screen still displays it in the point-to-point display mode, that is, only 1366×768 pixels in the middle of the liquid crystal screen are displayed while pixels at the surrounding position of the liquid crystal screen are not displayed but are filled with black picture. From the visual point of view, it is equivalent to increase the frame of the liquid crystal screen, and since the user usually operates in a manner of clicking images displayed on the screen when it is in the tablet usage mode, and no picture is displayed on the surrounding area of the liquid crystal screen at this time, it is not easy to cause the user's false operation.

According to the display mode provided in the embodiment of the present disclosure, the usage mode of the display terminal is detected in real time, and the effective use area of the display screen in the display terminal is adjusted according to the usage mode, so that the user's different requirements for the liquid crystal screen in different usage modes are satisfied, and thus the user experience is raised.

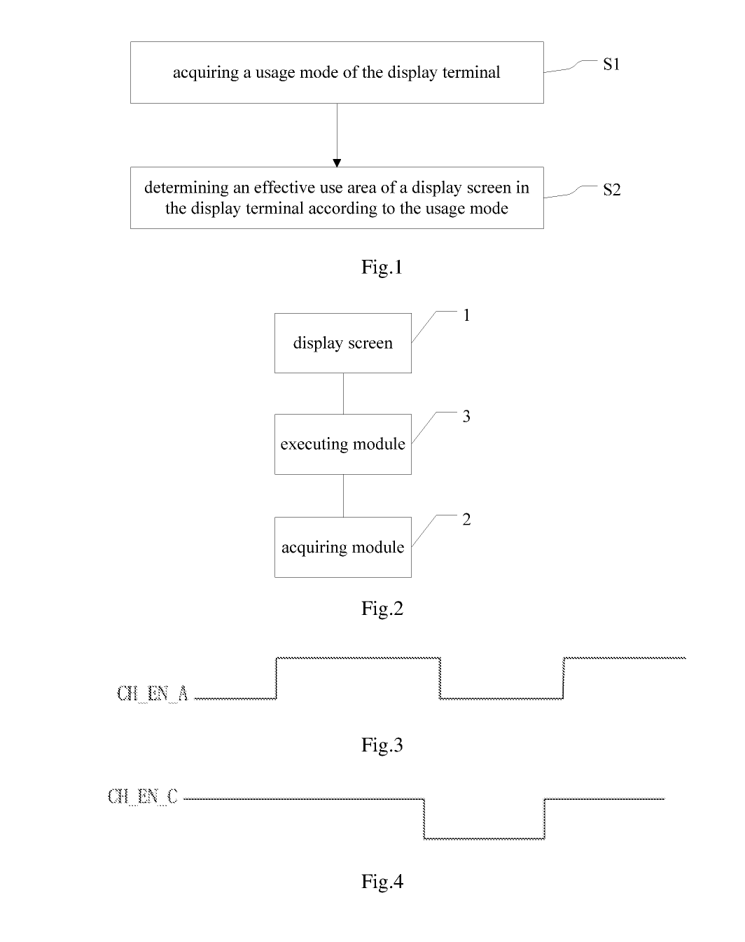

FIG. 2 is a schematic diagram of a display terminal provided in an embodiment of the present disclosure. Referring to FIG. 2, the display terminal comprises a display screen 1, an acquiring module 2 and an executing module 3.

In the embodiment as shown in FIG. 2, the acquiring module 2 is configured to acquire an usage mode of the display terminal. The executing module 3 is configured to determine an effective use area of the display screen 1 in the display terminal according to the usage mode.

In the embodiment as shown in FIG. 2, the acquiring module can comprise:

a first acquiring unit configured to determine the usage mode of the display terminal according to whether the display terminal is connected to an external device.

FIG. 3 shows a schematic diagram of an output signal of a first acquiring unit provided in an embodiment of the present disclosure. As shown in FIG. 3, the first acquiring unit can output a signal CH_EN_A according to whether the display terminal is connected to the external device. When there exists an external device connected to the display terminal, the signal is at a low level, and then the executing module enlarges the effective use area of the screen as much as possible; when there does not exist any external device connected to the display terminal, the signal is at a high level, and then the executing module narrows the effective use area of the screen.

Exemplarily, the acquiring module can further comprise:

a second acquiring unit configured to determine the usage mode of the display terminal according a control signal inputted by the user.

FIG. 4 shows a schematic diagram of an output signal of the second acquiring unit provided in an embodiment of the present disclosure. As shown in FIG. 4, the second acquiring unit can output a signal CH_EN_C according to the control signal inputted by the user. For example, the second acquiring unit can be a switch installed on the display terminal, and the user can operate the switch manually. When the switch is in a turn-on state, the signal CH_EN_C is at the high level, and the executing module enlarges the effective use area of the screen as much as possible. When the switch is turned off, the signal CH_EN_C is at the low level, the executing module narrows the effective use area of the screen. Exemplarily, the priority of the second acquiring unit can be higher than that of the first acquiring unit. For example, when the signal CH_EN_C is at the high level, it is regarded that the user needs to use in a narrow-frame display manner (i.e., PC usage mode). At this time, no matter what kind of level state the signal CH_EN_A is in, the executing module would enlarge the effective use area of the display screen as much as possible.

Alternatively, in the embodiment as shown in FIG. 2, the executing module can comprise:

a processing unit configured to perform a first process on image data inputted to the display screen when the usage mode is the PC usage mode, to obtain display data of a first resolution, where the first resolution is equal to a resolution of the display screen and perform a second process on image data inputted to the display screen when the usage mode is the tablet usage mode, to obtain display data of a second resolution, where the second resolution is smaller than a resolution of the display screen; and

an outputting unit configured to input display data processed and obtained by the processing unit to the display screen, where the display screen displays the display data received from the output unit in a point-to-point display mode.

In the embodiment of the present disclosure, the executing module can be integrated into TCON (timing controller) of the display terminal.

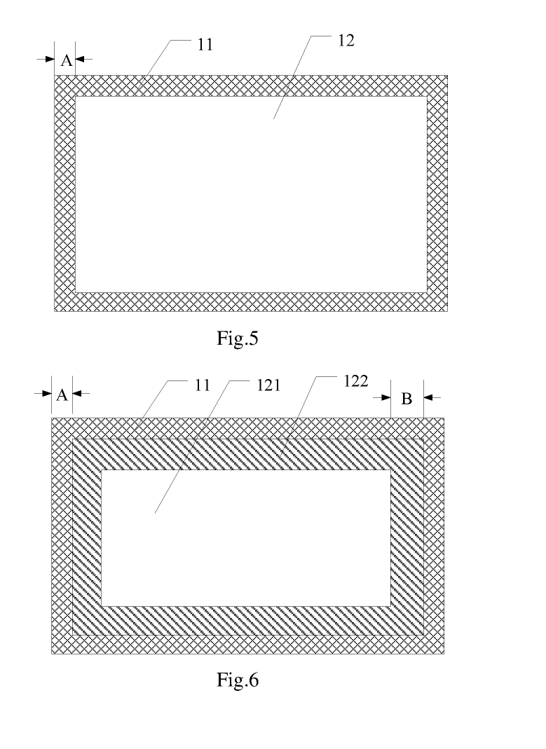

FIG. 5 shows a schematic diagram of a display terminal in a PC usage mode provided in an embodiment of the present disclosure. For example, as shown in FIG. 5, for a liquid crystal screen having a resolution of 1920×1080, a width of its actual frame 11 is A. when the usage mode is the PC usage mode, the display area is enlarged as much as possible, the resolution of display data outputted by TCON is 1920×1080, all the pixels on the display screen 12 are written into the corresponding image signal.

FIG. 6 shows a schematic diagram of a display terminal in a table usage mode provided in an embodiment of the present disclosure. For example, as shown in FIG. 6, for a liquid crystal screen having a resolution of 1920×1080, a width of its actual frame 11 is A. When the usage mode is the tablet usage mode, the effective use area of the display screen 12 is reduced. The resolution of display data outputted by TCON is 1366×768, the display data outputted by TCON would only output picture information to 1366×768 pixels in the middle area 121 of the screen 12, and the pixels in the surrounding area 122 having a width B are filled with black picture signals. From the visual point of view, it is equivalent to expand the frame width to A+B, so that the rate of the user's false operation is reduced.

In the display terminal according to the embodiment of the present disclosure, the usage mode of the display terminal is detected in real time, and the effective use area of the display screen in the display terminal is adjusted according to the usage mode, so that the user's different requirements for the liquid crystal screen in different usage modes are satisfied, and the user experience is raised.

The implementations described above are just used for describing the principle of the present disclosure, but not used for limiting the scope of the present disclosure. Those ordinary skilled in the art of relating technical field would further make various alternations and modifications without departing from the spirit and scope of the present disclosure. Therefore, all these alternations and modifications belong to the scope of the present disclosure, and the patent protection scope of the present disclosure shall be defined by the claims.

The present application claims the priority of a Chinese patent application No. 201410802581.0 filed on Dec. 19, 2014 Herein, the content disclosed by the Chinese patent application is incorporated in full by reference as a part of the present disclosure.

1. A displaying method, comprising following steps:
acquiring a usage mode of a display terminal; and
determining an effective use area of a display screen in the display terminal according to the usage mode.

2. The displaying method according to claim 1, wherein acquiring a usage mode of a display terminal comprises:
determining the usage mode of the display terminal according to whether the display terminal is connected to an external device.

3. The displaying method according to claim 2, wherein acquiring a usage mode of the display terminal further comprises:
determining the usage mode of the display terminal according to a control signal inputted by a user.

4. The displaying method according to claim 3, wherein a priority of the control signal inputted by the user is higher than that of the external device when the usage mode of the display terminal is determined.

5. The displaying method according to claim 1, wherein determining an effective use area of a display screen in the display terminal according to the usage mode comprising:
performing a first process on image data inputted to the display screen when the usage mode is a PC usage mode, to obtain display data of a first resolution, where the first resolution is equal to a resolution of the display screen, and the display screen displays the display data of the first resolution in a point-to-point display mode; and
performing a second process on image data inputted to the display screen when the usage mode is a tablet usage mode, to obtain display data of a second resolution, where the second resolution is smaller than a resolution of the display screen, and the display screen displays the display data of the second resolution in a point-to-point display mode.

6. A display terminal, comprising a display screen, and further comprising:
an acquiring module configured to acquire a usage mode of the display terminal; and
an executing module configured to determine an effective use area of the display screen in the display terminal according to the usage mode.

7. The display terminal according to claim 6, wherein the acquiring module comprises:
a first acquiring unit configured to determine the usage mode of the display terminal according to whether the display terminal is connected to an external device.

8. The display terminal according to claim 7, wherein the acquiring module further comprises:
a second acquiring unit configured to determine the usage mode of the display terminal according to a control signal inputted by a user.

9. The display terminal according to claim 8, wherein a priority of the second acquiring module is higher than that of the first acquiring unit.

10. The display terminal according to claim 6, wherein the executing unit comprises:
a processing unit configured to perform a first process on image data inputted to the display screen when the usage mode is a PC usage mode, to obtain display data of a first resolution, where the first resolution is equal to a resolution of the display screen and perform a second process on image data inputted to the display screen when the usage mode is a tablet usage mode, to obtain display data of a second resolution, where the second resolution is smaller than a resolution of the display screen; and
an outputting unit configured to input display data processed and obtained by the processing unit to the display screen, where the display screen displays the display data of the second resolution in a point-to-point display mode.

11. The displaying method according to claim 2, wherein determining an effective use area of a display screen in the display terminal according to the usage mode comprising:
performing a first process on image data inputted to the display screen when the usage mode is a PC usage mode, to obtain display data of a first resolution, where the first resolution is equal to a resolution of the display screen, and the display screen displays the display data of the first resolution in a point-to-point display mode; and
performing a second process on image data inputted to the display screen when the usage mode is a tablet usage mode, to obtain display data of a second resolution, where the second resolution is smaller than a resolution of the display screen, and the display screen displays the display data of the second resolution in a point-to-point display mode.

12. The displaying method according to claim 3, wherein determining an effective use area of a display screen in the display terminal according to the usage mode comprising:
performing a first process on image data inputted to the display screen when the usage mode is a PC usage mode, to obtain display data of a first resolution, where the first resolution is equal to a resolution of the display screen, and the display screen displays the display data of the first resolution in a point-to-point display mode; and
performing a second process on image data inputted to the display screen when the usage mode is a tablet usage mode, to obtain display data of a second resolution, where the second resolution is smaller than a resolution of the display screen, and the display screen displays the display data of the second resolution in a point-to-point display mode.

13. The displaying method according to claim 4, wherein determining an effective use area of a display screen in the display terminal according to the usage mode comprising:
performing a first process on image data inputted to the display screen when the usage mode is a PC usage mode, to obtain display data of a first resolution, where the first resolution is equal to a resolution of the display screen, and the display screen displays the display data of the first resolution in a point-to-point display mode; and
performing a second process on image data inputted to the display screen when the usage mode is a tablet usage mode, to obtain display data of a second resolution, where the second resolution is smaller than a resolution of the display screen, and the display screen displays the display data of the second resolution in a point-to-point display mode.

14. The display terminal according to claim 7, wherein the executing unit comprises:
a processing unit configured to perform a first process on image data inputted to the display screen when the usage mode is a PC usage mode, to obtain display data of a first resolution, where the first resolution is equal to a resolution of the display screen and perform a second process on image data inputted to the display screen when the usage mode is a tablet usage mode, to obtain display data of a second resolution, where the second resolution is smaller than a resolution of the display screen; and
an outputting unit configured to input display data processed and obtained by the processing unit to the display screen, where the display screen displays the display data of the second resolution in a point-to-point display mode.

15. The display terminal according to claim 8, wherein the executing unit comprises:
a processing unit configured to perform a first process on image data inputted to the display screen when the usage mode is a PC usage mode, to obtain display data of a first resolution, where the first resolution is equal to a resolution of the display screen and perform a second process on image data inputted to the display screen when the usage mode is a tablet usage mode, to obtain display data of a second resolution, where the second resolution is smaller than a resolution of the display screen; and
an outputting unit configured to input display data processed and obtained by the processing unit to the display screen, where the display screen displays the display data of the second resolution in a point-to-point display mode.

16. The display terminal according to claim 9, wherein the executing unit comprises:
a processing unit configured to perform a first process on image data inputted to the display screen when the usage mode is a PC usage mode, to obtain display data of a first resolution, where the first resolution is equal to a resolution of the display screen and perform a second process on image data inputted to the display screen when the usage mode is a tablet usage mode, to obtain display data of a second resolution, where the second resolution is smaller than a resolution of the display screen; and
an outputting unit configured to input display data processed and obtained by the processing unit to the display screen, where the display screen displays the display data of the second resolution in a point-to-point display mode.
